(19) United States
(12) Patent Application Publication
(10) Pub. No.: US 2008/0230512 A1
(43) Pub. Date: Sep. 25, 2008

(54) Printed Circuit Board and Method for Processing Printed Circuit Board

(75) Inventors: Kunio Arai, Ebina-shi (JP); Haruo Akahoshi, Hitachi-shi (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI VIA MECHANICS, LTD., Ebina-shi (JP)

(21) Appl. No.: 12/110,466

(22) Filed: Apr. 28, 2008

Related U.S. Application Data
(63) Continuation of application No. 11/117,505, filed on Apr. 29, 2005.

(30) Foreign Application Priority Data
Apr. 30, 2004 (JP) 2004-136905

(51) Int. Cl. H01B 13/00

(52) U.S. Cl. 216/17

(57) ABSTRACT

The invention is to provide a printed circuit board in which advance of packaging density of the printed circuit board and reduction in production cost can be attained while processing quality can be made uniform, a method for processing the printed circuit board and a method for producing the printed circuit board.

There is provided a printed circuit board including an alternate laminate of electric conductor layers and electrically insulating layers, wherein a coating layer capable of absorbing laser light but insoluble in an etching solution dissolving the electric conductor layers is provided on a front surface of a first one of the electric conductor layers. In this case, the coating layer may be provided on a front surface of a rear one of the electric conductor layers. Each of the electric conductor layers may contain Cu as a main component while the coating layer may contain CuO as a main component. The coating layer may have a thickness not thinner than 0.6 μm.

### CROSS REFERENCE TO RELATED APPLICATIONS

This application is a divisional of U.S. patent application Ser. No. 11/117,505, filed Apr. 29, 2005, which claims priority under 35 U.S.C. §119 to Japanese Patent Application No. 2004-136905, filed Apr. 30, 2004, the entire disclosures of which are herein expressly incorporated by reference.

### FIELD OF THE INVENTION

The present invention relates to a printed circuit board and a method for processing the printed circuit board.

### BACKGROUND ART

In a multilayer printed circuit board, blind holes or through-holes for connecting sheets of copper foil to one another are formed in order to electrically connect sheets of copper foil (electric conductors) disposed in respective layers. The blind holes or through-holes formed thus are plated to thereby electrically connect the sheets of foil.

In the case of CO₂ laser light, if energy is low, it is impossible to process the sheets of copper foil because large part of the applied laser light is reflected on surfaces of the sheets of copper foil. Therefore, for example, for formation of a blind hole for connecting a first layer (copper foil on a front surface) and a second layer (copper foil disposed under the first layer with an electrical insulator interposed therebetween), a hole (window) is formed in the first layer by etching or the like in advance so that the window formed thus is irradiated with CO₂ laser light to thereby remove the electrical insulator (JP-A-2002-118344).

CuO (cupric oxide) has a very low reflectivity because the electric conductivity and thermal conductivity of CuO are far lower than those of pure copper (with a purity of 98% or higher), and is black. CuO layers about 0.2 μm thick formed on surfaces of copper foils 1 have been used to process the copper foils using the above mentioned property of CuO.

When the CuO layer is formed on the surface of copper foil 1, a heat spot having a high temperature is created at a position irradiated with CO₂ laser light. As a result, the copper foil is melted at the position so that a hole can be formed in the copper foil.

The advance of packaging density of a printed circuit board and reduction in production cost of the printed circuit board have been required more intensively in recent years.

In the case of the technique described in JP-A-2002-118344, the production cost of a printed circuit board increases if a window needs to be provided accurately, and it is difficult to advance the packaging density of the printed circuit board if the window needs to be enlarged.

Even in the case where the CuO layer is provided on the surface of copper foil, it is possible to process the copper foil to form a hole if energy is increased. However, because excessive energy is supplied to an electrically insulating layer under the hole at the same time that the hole is formed in the copper foil, the electrically insulating layer just under the hole is gouged out so largely that the overhang length of copper becomes large. As a result, the hole is shaped like a so-called beer barrel in the sectional view. In such a case, the plating thickness of the corner in the bottom of the hole may become thin because the plating is concentrated in the inlet of the hole, or a void may be generated in the inside of the hole because the inlet is blocked with the plating. Accordingly, reliability on electrical connection of layers is reduced.

Moreover, molten copper often remains as a ring-like protrusion around the inlet of the hole. If the height of the protrusion exceeds 4 μm, the height of the protrusion is made higher by plating, so that the periphery of the inlet of the hole is rounded like a ring. Accordingly, there is a problem not only in deterioration of external appearance but also in a pattern-forming process as an after-process.

### SUMMARY OF THE INVENTION

An object of the invention is to provide a printed circuit board in which advance of packaging density of the printed circuit board and reduction in production cost can be attained while processing quality can be made uniform, a method for processing the printed circuit board.

To solve the aforementioned problem, in accordance with a first aspect of the invention, there is provided a printed circuit board including an alternate laminate of electric conductor layers and electrically insulating layers, wherein a coating layer capable of absorbing laser light but insoluble in an etching solution dissolving the electric conductor layers is provided on the front surface of the first one of the electric conductor layers.

In this case, the coating layer may be provided on a front surface of the electric conductor layer of the rear side of the board.

The printed circuit board may be formed so that each of the electric conductor layers contains Cu as a main component while the coating layer contains CuO as a main component.

The coating layer may have a thickness not thinner than 0.6 μm.

The printed circuit board may be formed so that each of inner conductor layers disposed as inner layers contains Cu as a main component; and the surface roughness of the inner conductor layer in which a through-hole is processed by laser light is selected to be not smaller than 0.2 μm.

According to a second aspect of the invention, there is provided a method of producing a printed circuit board defined in the first aspect, including removing an overhang portion of a hole inlet generated by laser processing, by treating the overhang portion with a treating solution incapable of dissolving the coating layer and the electrically insulating layer but capable of mainly dissolving the Cu component in the printed circuit board.

In this case, the treating solution may be one member selected from the group consisting of a solution of ferric chloride (FeCl₃), a solution of ammonium persulfate and a solution of sodium persulfate.

According to a third aspect of the invention, there is provided a method of processing a printed circuit board, including the steps of: performing laser processing to expose an alignment mark formed in an inner conductor layer in the printed circuit board; and processing the printed circuit board on the basis of the exposed alignment mark.

According to a fourth aspect of the invention, there is provided a method of processing a printed circuit board, including processing an n-th conductor layer by a laser beam having a beam diameter smaller than the diameter of a hole formed in an (n−1)th conductor layer (n is an integer satisfying n≧2) from a front surface of the printed circuit board.

Because an electric conductor layer can be processed by laser light, especially CO₂ laser light, the processing process can be reduced while the processing efficiency can be improved. In addition, because a hole shape suitable to the plating process can be obtained, the quality of the hole can be improved.

### BRIEF DESCRIPTION OF THE DRAWINGS

FIGS. 1A and 1B are sectional views typically showing a printed circuit board according to the invention (Embodiment 1);

FIG. 2 is a graph showing the relation between the pulse width of CO₂ laser light and the diameter of hole formed;

FIGS. 3A to 3G are views typically showing a process of forming a blind hole according to the invention;

FIGS. 4A to 4D show an example in which the first and second layers are connected to each other according to the invention (Embodiment 2);

FIGS. 5A to 5D show an example in which the first to third layers are connected to one another according to the invention (Embodiment 3);

FIGS. 6A to 6D show an example in which the second and third layers are connected to each other in the absence of the first layer according to the invention (Embodiment 4);

FIGS. 7A to 7E show an example in which a through-hole from the first layer to the rear side of the board is formed according to the invention (Embodiment 5); and

FIG. 8 is a view showing a result of plating shown in FIGS. 7A to 7E.

### PREFERRED EMBODIMENTS OF THE INVENTION

The invention will be described below with reference to the drawings.

### Embodiment 1

Processing of a first layer of copper foil disposed in a printed circuit board will be described first. Incidentally, as will be described later, a subject of the invention is a printed circuit board which is provided as a material applied to a process of producing a completed printed circuit board.

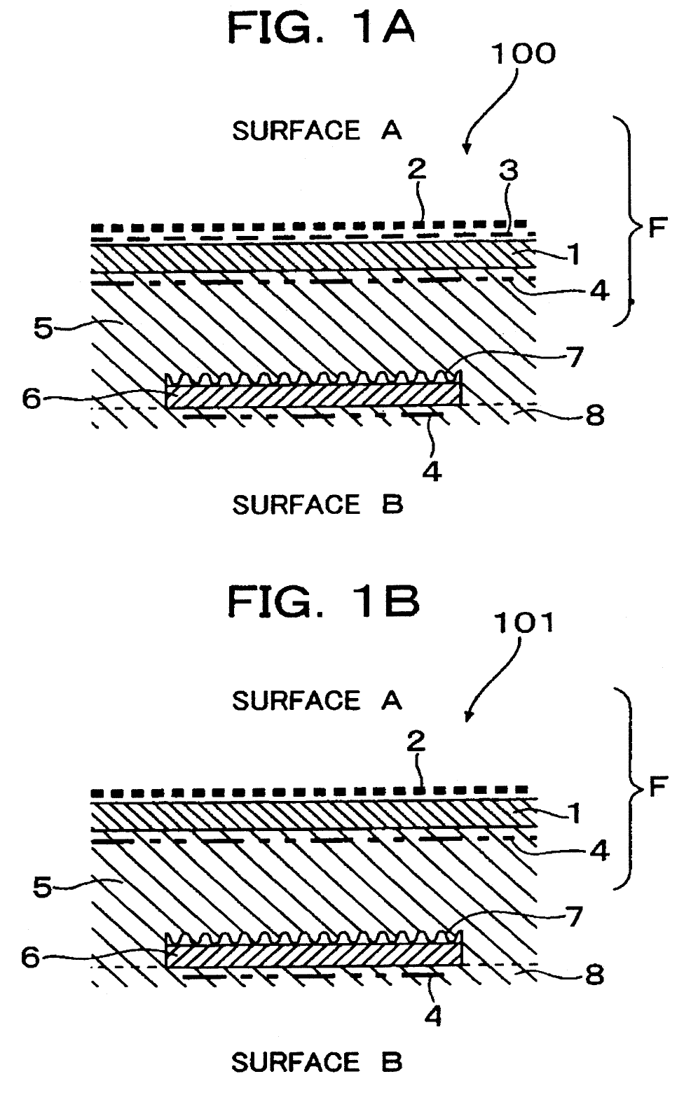

FIG. 1A is a sectional view typically showing a first printed circuit board 100 according to the invention.

In the printed circuit board according to the invention, the thickness of a sheet of copper foil 1 which is an electric conductor layer provided as a first layer (hereinafter referred to as “first layer”) is from 5 μm to 18 μm. A Cu₂O layer 3 containing Cu₂O (cuprous oxide) as a main component as represented by the thick broken line is formed in a portion of a surface (surface A side) abutting on copper. A CuO layer 2 containing CuO (cupric oxide) as a main component as represented by the thin broken line is formed on an upper side (surface A side) of the Cu₂O layer 3. The thickness of the CuO layer 2 in the invention is not thinner than 0.6 μm (preferably not thinner than 0.8 μm). That is, the CuO layer 2 is formed to have a thickness about three times as large as the thickness of the CuO layer 2 used in the conventional printed circuit board (i.e. the thickness of the conventional CuO layer 2 is not thicker than 0.2 μm). A surface (mat surface on a surface B side in FIG. 1A) 4 abutting on an electrically insulating layer (hereinafter referred to as “first electrically insulating layer”) 5 of copper foil 1 as represented by the one-dot chain line is subjected to a roughening and rust-preventing treatment in a material stage.

For example, the thickness of the CuO layer can be selected to be 0.8 μm when the CuO layer is immersed in a solution containing NaClO₂ (sodium chlorite), NaOH (sodium hydroxide) and Na₃PO₄.12H₂O (sodium tertiary phosphate dodecahydrate) at 70° C. for 7 minutes. For example, the thickness of the CuO layer can be selected to be 1 μm when the immersion time is extended.

Incidentally, when the thickness 0.8 μm of the CuO layer is evaluated by weight based on the IPC standard, the weight of the CuO layer is from 0.46 mg/cm² to 0.52 mg/cm². In the case where the thickness of the CuO layer is 0.2 μm, the weight of the CuO layer is from 0.12 mg/cm² to 0.13 mg/cm². (The weight of a sample is measured before and after dissolution of CuO in the condition that the sample is washed with water, dried at 80° C. for 30 minutes and then immersed in 5% sulfuric acid at 25° C. for 1 minute.)

The thickness of the first electrically insulating layer is from 25 μm to 100 μm.

A sheet of copper foil 6 which is an electric conductor layer (hereinafter referred to as “second layer”) provided as a second layer is disposed on a lower side of the first electrically insulating layer 5. The sheet of copper foil 6 has a roughened surface 7 (surface A side) as represented by the wavy line, and a surface 4 (surface B side) abutting in an electrically insulating layer (hereinafter referred to as “second electrically insulating layer”) and subjected to a roughening and rust-preventing treatment in a material stage in the same manner as in the first layer. Although the boundary between the first electrically insulating layer 5 and the second electrically insulating layer 8 is expressed by the broken line in FIG. 1A in order to distinguish the two layers 5 and 8 from each other, the two layers 5 and 8 are substantially integrated with each other.

When a blind hole is to be processed, the thickness of the sheet of copper foil 6 is selected to be not thinner than 9 μm. When a through-hole is to be processed, the thickness of the sheet of copper foil 6 is selected to be not thicker than 18 μm (preferably not thicker than 12 μm). Hereinafter, the electric conductor layer 2 in the case where the blind hole is to be processed is referred to as “conductor layer S” whereas the electric conductor layer 2 in the case where the through-hole is to be processed is referred to as “conductor layer “T”.

A conductor layer S/T or a plurality of conductor layers S/T may be disposed in any positions after the second layer in accordance with the purpose of the printed circuit board.

Incidentally, the surface 4 of each of the first and second layers is a surface formed by a copper foil maker in advance. After roughened by an etching treatment or a granular copper plating treatment, the surface of the sheet of foil has been already subjected to a chromate treatment (CrO₃, Cr₂O₃) or a plating treatment with Zn, Sn, Mo, etc. for the purpose of preventing rust.

The surface 7 of the second layer is a surface formed by a board maker after the copper foil and the electrically insulating layer are integrated with each other. As a method for forming the surface 7, there may be used a method of forming a CuO layer having a needle-like structure about 0.2 μm thick on a surface of a sheet of copper foil and then reducing the CuO layer to form a needle-like rough surface or etching the CuO layer with an acid or alkaline etching solution (e.g. hydrogen peroxide solution) to form a surface having granular, patal-like, polygonal pyramid-like or scaly protrusions with a height of 1 to 3 μm.

FIG. 1B is a sectional view typically showing a second printed circuit board 101 according to the invention.

The second printed circuit board 101 has the same structure as that of the first printed circuit board 100 except that there is no Cu₂O (cuprous oxide) layer 3 formed on a surface of copper foil 1.

Hereinafter, the copper foil 1 having a CuO layer 2 or having a CuO layer 2 and a Cu₂O layer 3 on its surface is referred to as “conductor layer F”.

Next, the point of difference between the invention and the background art will be described.

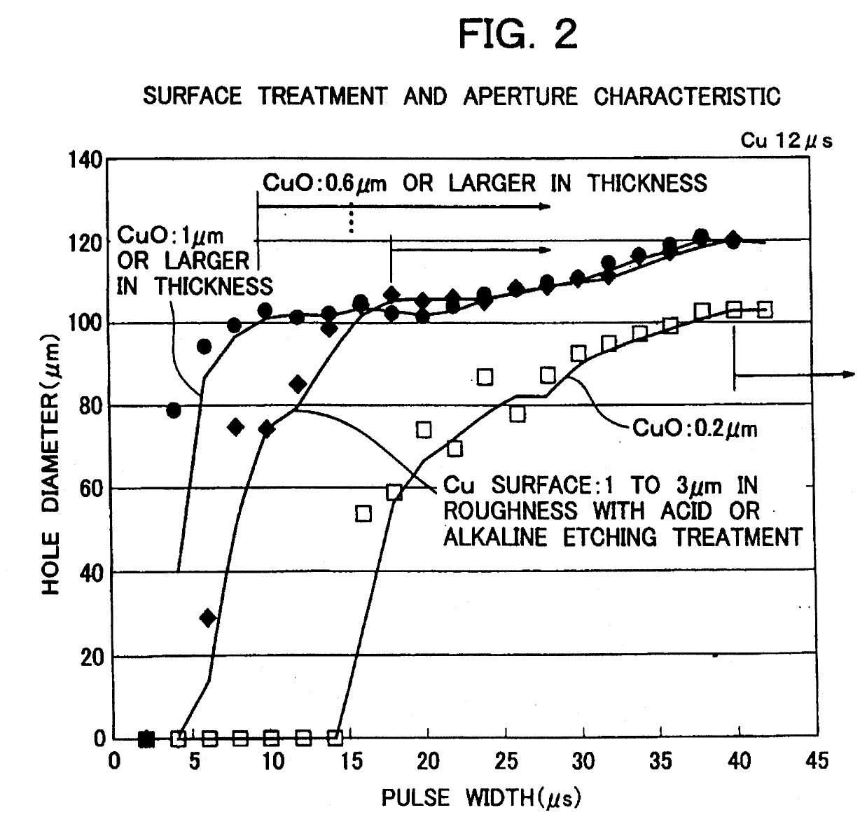

FIG. 2 is a graph showing the relation between the pulse width of CO₂ laser light and the diameter of hole to be processed. In FIG. 2, the black dots show the case where the CuO layer is 1 μm thick, the black squares show the case where a roughness of 1 to 3 μm is provided in the surface by an etching treatment, and the white squares show the case where the CuO layer is 0.2 μm thick. Incidentally, the thickness of the sheet of copper foil is 12 μm and the peak intensity of the laser light is constant.

As is obvious from FIG. 2, for example, when a hole of 100 μm needs to be processed, the hole can be processed by light with a pulse width of 10 μs in the case where the CuO layer is 1 μm thick. In the case of an etching treatment, it is however necessary to set the pulse width at about 20 μs. In the case where the CuO layer is 0.2 μm thick, it is also necessary to set the pulse width at about 40 μs. That is, it is apparent that the pulse energy required for processing the hole according to the invention is in a range of from a half of the conventional pulse energy to a quarter of the conventional pulse energy.

Incidentally, a result of the case where the CuO layer is 0.6 μm thick is not expressed as a curve in FIG. 2. It is however possible to process a hole of 100 μm by light with a pulse width of 16 μs as shown in FIG. 2, so that the pulse energy can be reduced compared with the case of an etching treatment.

Because the pulse energy can be reduced, it is possible not only to increase the processing speed but also to prevent the hole formed in the electrically insulating layer from being shaped like a beer barrel.

Incidentally, the electrical conductivity and thermal conductivity of Cu₂O are higher than those of CuO but far lower than those of pure copper. Accordingly, also in the case where a Cu₂O layer is formed between the copper layer and the CuO layer, the same effect as in the case of the CuO layer can be obtained.

Next, a procedure for producing a printed circuit board according to the invention will be further described.

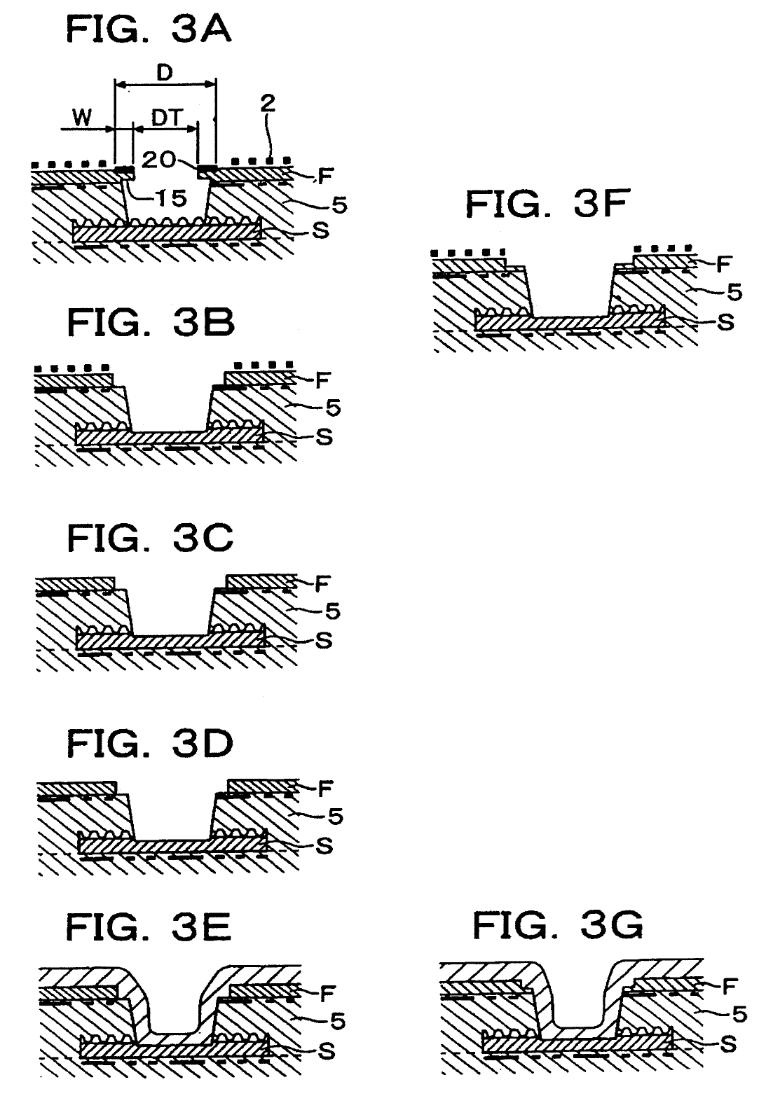

FIGS. 3A to 3G are views typically showing a process of forming a blind hole according to the invention. FIG. 3A shows a state in which the step of forming the blind hole is completed. FIG. 3B shows a state in which the step of reducing the thickness of a glossy surface or removing the glossy surface is completed. FIG. 3C shows a state in which the step of removing an oxidized film, that is, a CuO layer, is completed. FIG. 3D shows a state in which the step of swelling and desmearing is completed. FIG. 3E shows a state in which the step of plating is completed.

The shape of the hole after the hole-forming step will be described first.

As shown in FIG. 3A, when the hole is processed by CO₂ laser light, a ring-like glossy surface (the solid line in FIG. 3A) 20 is formed in the periphery of the inlet of the hole while the diameter of the inlet of the hole becomes smaller than the diameter of the inside of the hole. The portion where the sheet of copper foil 1 hangs over the inside of the hole is an overhang portion 15.

The glossy surface is formed as follows.

That is, a part of energy applied for processing the first layer diffuses radially. As a result, a contour-like temperature gradient is generated with the processed portion as its center. A portion having a temperature reaching the evaporating temperature is removed. On the other hand, a region having a temperature not lower than the liquefying temperature but lower than the vaporizing temperature is melted but solidified when laser light irradiation is completed. On this occasion, oxygen bonded to Cu with the advance of melting is liberated. That is, because CuO is reduced, large part of the re-solidified portion contains only a copper component, so that a glossy surface 20 is formed. The width W of the glossy surface 20 is given by (D−DT)/2 in which D is the beam diameter of the laser light, and DT is the final diameter of the hole. The width W of the glossy surface 20 depends on the beam mode (transverse mode), the output density, the pulse shape and the diameter of the hole but is generally in a range of from 20 to 50 μm.

The contour-like temperature gradient generated radially on the basis of diffusion of energy also depends on the energy distribution gradient of the beam, that is, depends on the beam mode (transverse mode). If the energy used for processing is constant, the effective diameter DT of the inlet of the hole becomes largest at a top hat distribution beam (hereinafter referred to as “top hat beam”) having an energy distribution nearly uniform in a direction perpendicular to the optical axis. The effective diameter DT of the inlet of the hole becomes secondly largest at a beam (hereinafter referred to as “round top beam”) having an energy distribution spherical in the direction of the optical axis. The effective diameter DT of the inlet of the hole becomes smallest at a beam (hereinafter referred to as “Gaussian beam”) having an energy distribution shaped like a Gaussian curve in the direction of the optical axis. The width W of the glossy surface is smallest at the top hat beam, secondly smallest at the round top beam and largest at the Gaussian beam. Accordingly, when the beam mode is selected, the width W of the glossy surface can be controlled.

The contour-like temperature gradient generated radially on the basis of diffusion of energy further depends on the peak output in the processed portion, that is, depends on the pulse mode (longitudinal mode). If the pulse energy is constant, the width W of the glossy surface decreases as the peak output increases and as the pulse width decreases (the pulse width of rectangular wave is shortest). Accordingly, the width W of the glossy surface can be also controlled by the pulse mode (longitudinal mode). However, if the peak output density becomes high, the side wall of the hole in the second layer (electrically insulating layer) is removed because the width W of the glossy surface becomes small but the amount of decomposition products per unit time in the inside of the hole increases. As a result, the overhang length increases.

Although the hole can be formed by the conventional CuO treatment, output density not lower than 5 MW/cm² (5×10⁶ W/cm²) is required for forming a hole of a predetermined diameter in the first layer because the amount of laser light absorbed is small. For this reason, the overhang length of the first layer may exceed 20 μm.

On the other hand, when the invention is used for thickening the CuO layer, the overhang length can be reduced to be not larger than 5 μm because a hole of a predetermined diameter can be formed even in the case where the output density is not higher than about 2 MW/cm².

Incidentally, the overhang length becomes large particularly in the case of a bursting treatment (processing method for applying pulse laser light onto a place continuously).

As described above, if there is the overhang portion 15, the reliability of the plating step is reduced.

Therefore, in the invention, the overhang portion 15 is processed as follows.

That is, a solution containing 370 g of ferric chloride dissolved in 1 liter of water, a solution containing 200 g of ammonium persulfate dissolved in 1 liter of water or a solution containing 150 g of sodium persulfate dissolved in 1 liter of water is used as an etching solution. When the etching time is controlled, only the copper component can be dissolved without removal of the resin from the electrically insulating layer. As a result, the ring-like molten copper portion in the periphery of the inlet of the hole can be removed selectively, so that the overhang portion 15 can be entirely removed as shown in FIG. 3B. The step of removing the overhang portion 15 is hereinafter referred to as “overhang removing step”.

Incidentally, when degreasing is performed before the overhang removing step, the time required for the overhang removing step can be shortened.

After the CuO layer is then removed by the oxidized film removing step using 3% dilute sulfuric acid as an etching solution in the same manner as in the background art (FIG. 3C), the desmearing step is performed (FIG. 3D) so that the resin residue remaining on the side wall of the electrical insulator and the front surface of the second layer can be removed. Then, the plating step is performed (FIG. 3E).

As shown in FIG. 3E, plating, excellent in shape, can be performed because the overhang portion 15 has been already removed.

Incidentally, FIG. 3F shows the case where the processing time in the overhang removing step is shortened. FIG. 3G shows the shape of plating in this case. Also in this case, the plating portion can be formed smoothly.

Although the front surface of the second layer may be removed by the overhang removing step, there is no practical problem because the removed thickness is very thin (about 1 μm).

For example, in the case where the electrically insulating layer is made of an epoxy resin, the sheet of copper foil in the lower portion of the glossy surface 20 may be peeled from the electrical insulator by heat at the time of processing. It is however possible to substantially eliminate the generated peeling because the copper foil portion peeled thus can be removed by the overhang removing step.

### Embodiment 2

Next, processing of inner layers (the second layer, the electric conductor layer in the second layer, etc.) disposed in the printed circuit board will be described.

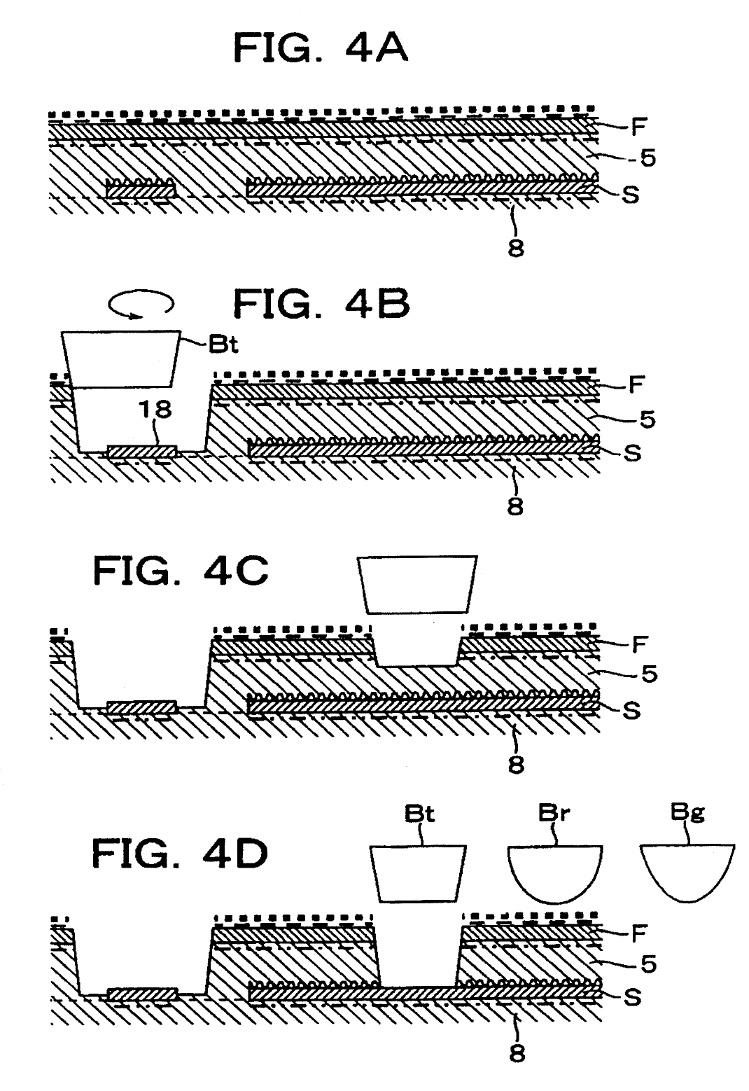

FIGS. 4A to 4D show an example in which the first and second layers ate connected to each other according to the invention. Conductor layers F and S are disposed as the first and second layers respectively. Fiducial marks (alignment marks) 18 are formed at the same time that circuits in the second layer are formed.

Next, a procedure of processing will be described.

(1) One of the fiducial marks 18 is exposed from the state shown in FIG. 4A. In this case, a beam (Bt) having a top hat type energy distribution is rotated around the center axis of the fiducial mark 18 while the radius of the beam is changed as shown in FIG. 4B. In this manner, the first layer (conductor layer F) is processed by a spot facing treatment. On this occasion, the intensity of the beam can be increased to a certain degree because the second layer is the conductor layer S.

(2) A hole is formed in a desired position of the first layer with reference to the exposed fiducial mark 18.

When the diameter of the inlet of the hole in the first layer on this occasion is 100 μm, for example, the pulse frequency and the average output are set to be 1 KHz and 4 W respectively as the processing condition of the first layer. Incidentally, if the processing condition of the first layer on this occasion is selected so that the electrically insulating layer 5 just under the processed portion can be kept as sufficiently as possible, the inclination of the wall surface of the hole can be predetermined arbitrarily (FIG. 4C).

(3) The electrically insulating layer 5 is processed up to the second layer (FIG. 4D). On this occasion, the diameter of the beam is selected to be smaller than the diameter of the hole formed in the first layer. When the inclination rate of the side wall (the rate of the diameter of the bottom of the hole to the diameter of the inlet of the hole) is to be set to be not lower than about 90%, processing is performed by a beam (Bt in FIG. 4D) having a top hat type energy distribution. When the inclination rate of the side wall is to be set to be in a range of from 80% to 90%, processing is performed by a beam (Br in FIG. 4D) having a round top hat type energy distribution (the energy distribution in the round top hat type is spherical whereas the energy distribution perpendicular to the optical axis in the top hat type distribution is nearly uniform). When the inclination rate of the side wall is to be set to be not higher than 80%, processing is performed by a beam (Bg in FIG. 4D) having a Gaussian type energy distribution.

Incidentally, it is preferable that the energy required for processing the electrically insulting layer 5 is selected to be in a range of from ⅓ to ⅕ as much as the energy required for processing the first layer.

When the diameter of the beam for processing the electrically insulating layer is selected to be smaller than the diameter of the hole formed in the first layer, the gouging of the side wall of the hole (the copper overhang in the inlet of the hole) can be reduced.

### Embodiment 3

Next, a procedure of processing the blind hole for connecting the first, second and third layers disposed in the printed circuit board will be described.

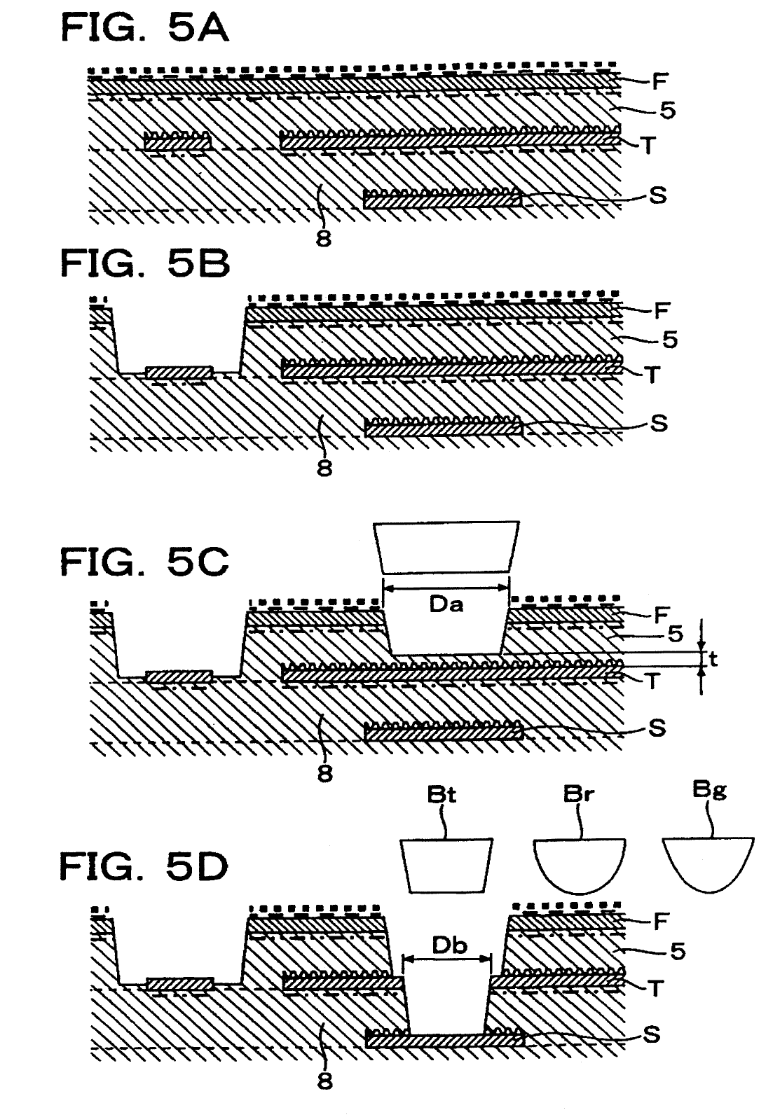

FIGS. 5A to 5D show an example in which the first to third layers are connected to one another according to the invention.

(1) One of the fiducial marks 18 is exposed from the state shown in FIG. 5A. In this case, a beam (Bt) having a top hat type energy distribution is rotated around the center axis of the fiducial mark 18 while the radius of the beam is changed. In this manner, the first layer (conductor layer F) is processed by a spot facing treatment. On this occasion, it is necessary to consider that the sheet of copper foil T is prevented from being damaged because the second layer is the sheet of copper foil T (FIG. 5B).

(2) A hole is formed in a desired position of the first layer with reference to the exposed fiducial mark 18.

In this embodiment, a hole having a diameter of 150 to 200 μm in terms of the diameter Da of the inlet of the hole in the first layer is processed because the hole reaching the third layer needs to be processed (FIG. 5C).

(3) The electrically insulating layer 5 is processed up to the second layer. On this occasion, the diameter of the beam is selected to be smaller than the diameter of the hole formed in the first layer. It is preferable that the electrical insulator having a thickness of 5 to 15 μm (dimension t in FIG. 5C) remains on the front surface of the second layer.

(4) A hole is formed in the second layer. On this occasion, the diameter Db of the beam is selected to be smaller (e.g. 75 to 125 μm) than the diameter Da of the beam used for processing the electrical insulator between the first and second layers. As described in (3) in Embodiment 3, any one of the top hat distribution, the round top hat distribution and the Gaussian distribution is used as the energy distribution in accordance with the required inclination rate of the side wall (FIG. 5D).

As described above, if the diameter of the laser beam is selected to be smaller than the diameter of the hole formed in the (n−1)th conductor layer from the front surface (n is an integer satisfying n≧2) when the n-th conductor layer from the front surface needs to be processed, the overhang of the (n−1)th conductor layer can be reduced.

### Embodiment 4

Next, a procedure of processing the blind hole (e.g. in a conformal board) in the case where the first layer is absent in a position connecting the second and third layers will be described.

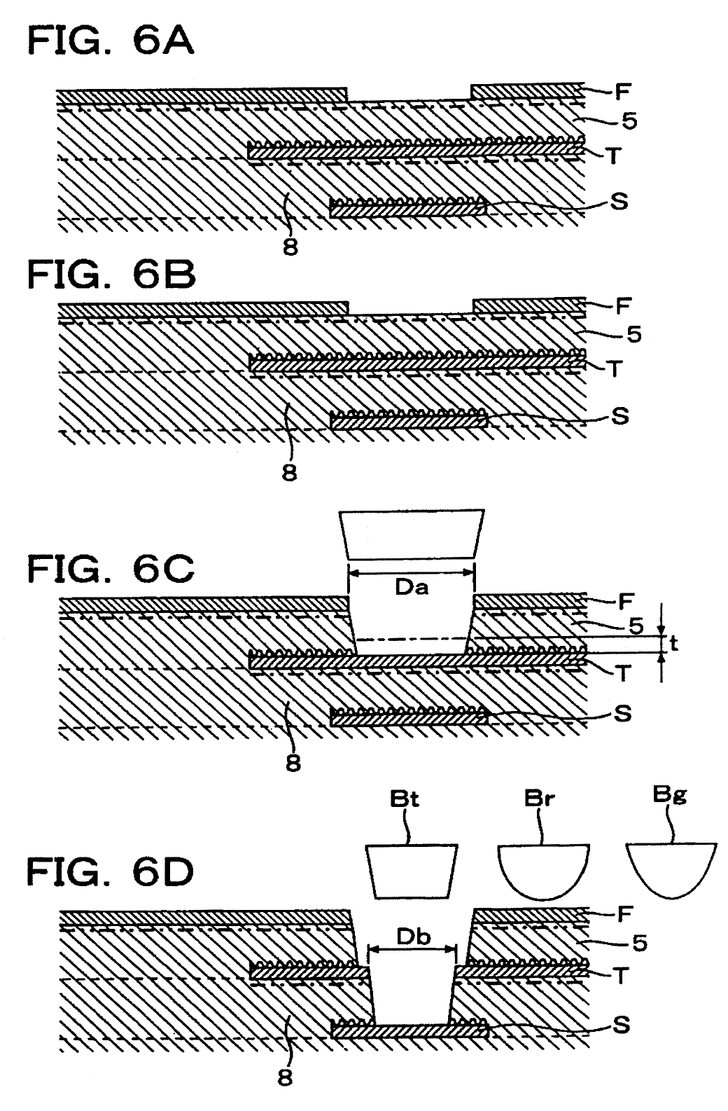

FIGS. 6A to 6D shows an example in which the second and third layers are connected to each other in the absence of the first layer according to the invention.

This case is the same as the case where the step (1) in Embodiment 3 is terminated. Duplicated Description will be omitted.

### Embodiment 5

Next, a procedure of processing the through-hole according to the invention will be described.

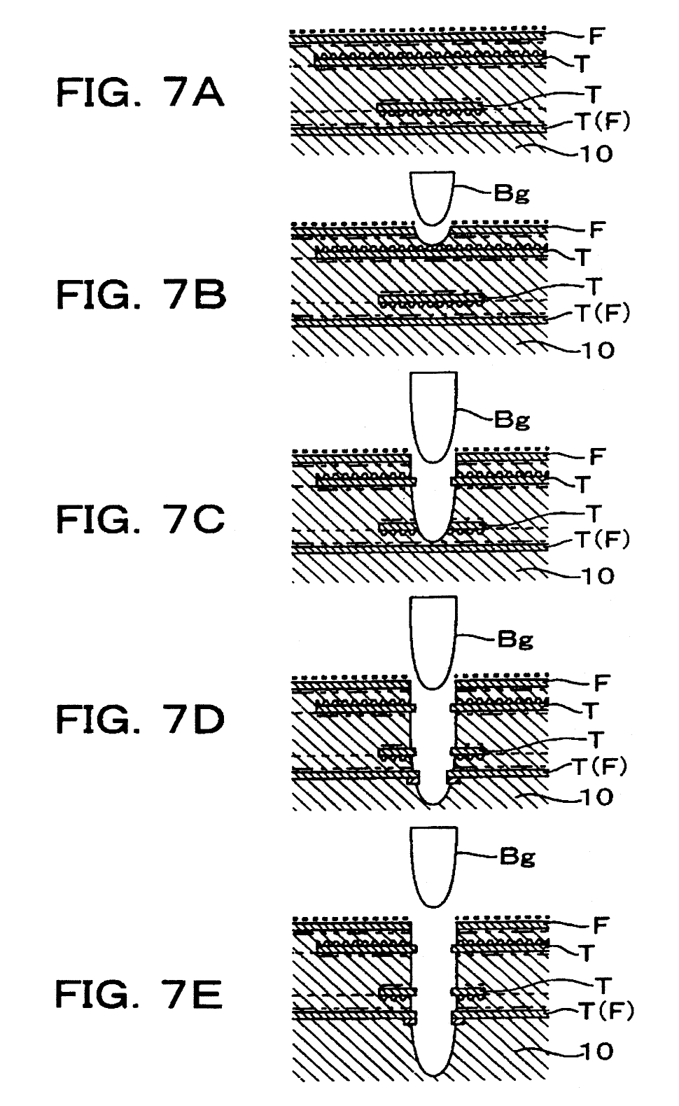

FIGS. 7A to 7E show an example in which the through-hole from the first layer on the front side to the fourth layer on the rear side is formed according to the invention. When the through-hole needs to be processed, a backup plate is generally disposed between the printed circuit board and a table to prevent the table from being damaged because the front end of the laser beam pierces the conductor layer on the rear side when processing is completed. Incidentally, the conductor layer on the rear side as shown in FIGS. 7A to 7E may be either the conductor layer F or the conductor layer T.

When the through-hole needs to be formed, a beam having a Gaussian type energy distribution is selected so that the through-hole excellent in quality can be processed.

For example, in the case where the backup plate 10 as shown in FIGS. 7A to 7E is used for forming the through-hole 100 μm thick (FIG. 7A), the pulse frequency is selected to be 1 KHz. A hole is formed in the conductor layer F by a beam having one pulse with a pulse width of 30 to 40 μs at the average output of the processed portion of 7 to 9 W (FIG. 7B). A hole passing through the third layer from the electrical insulator just under the first layer is formed by a beam having one pulse with a pulse width of 80 to 100 μs at the average output of the processed portion of 16 to 20 W (FIG. 7C). A hole passing through the fourth layer from the electrical insulator just under the third layer is further formed by a beam having one pulse with a pulse width of 80 to 100 μs (FIG. 7D). The diameter of the hole in the fourth layer is enlarged by a beam having one pulse with a pulse width of 50 to 60 μs at the average output of the processed portion of 12 to 14 W (FIG. 7E). Thus, a hole little in variation of the hole diameter in each portion can be processed.

When processing is performed in the aforementioned condition, the diameters of the respective portions are, for example, as follows.

The inlet diameter D1 of the conductor layer F is about 75 μm. The diameter D2 of each of the electrically insulators is from about 90 to 100 μm. The hole diameter of each of the intermediate conductor layers T is from 80 to 90 μm. The hole diameter of the conductor layer T on the rear side is about 50 μm. That is, the hole is finished so that the overhang length of the hole inlet is not larger than 15 μm, the length of protrusion of each of the inner conductor layers is not larger than 10 μm and the overhang length of the hole outlet is not larger than 25 μm.

In the case where the lower surface of the fourth layer is floated up without use of the backup plate, the hole diameter of the fourth layer can be prevented from becoming small. Accordingly, when the pulse frequency is selected to be 1 kHz, a hole can be formed in the conductor layer F by a beam having one pulse with a pulse width of 30 to 40 μs at the average output of the processed portion of 7 to 9 W, and a hole passing through the fourth layer from the electrical insulator just under the first layer can be formed by a beam having one pulse with a pulse width of 80 to 160 μs at the average output of the processed portion of 20 to 32 W.

Incidentally, the reason why a hole from the electrical insulator just under the conductor layer F to the fourth layer can be processed at once when the backup plate 10 is not used is that energy can be increased because decomposition products generated by the processing blow out to the front and rear sides so that the decomposition products are not confined in the inside of the hole when the backup plate 10 is not used.

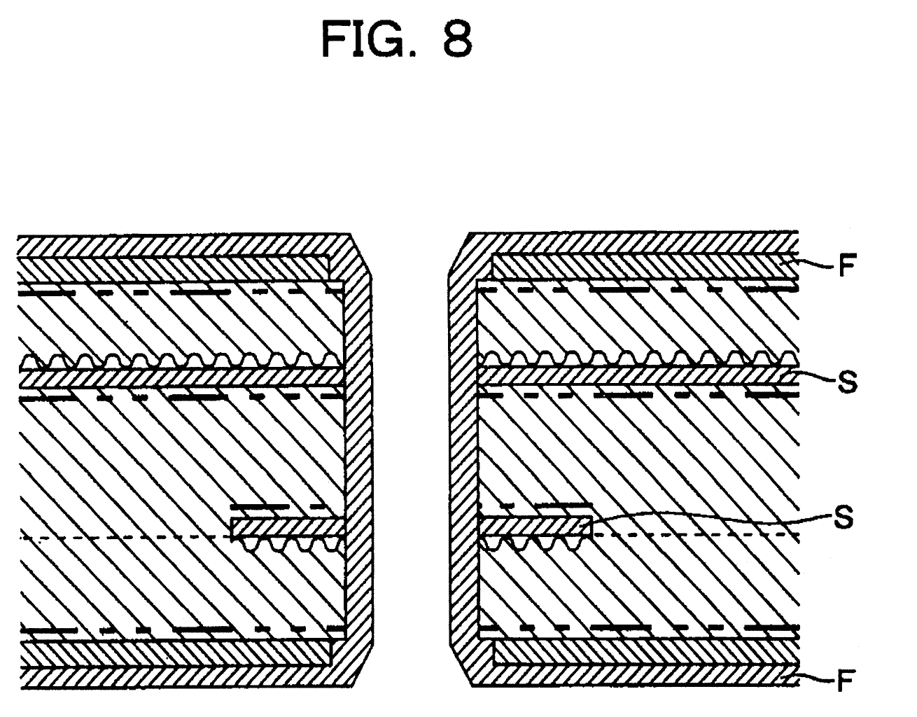

FIG. 8 is a sectional view showing a state in which the plating step is completed in the case where the process of producing a printed circuit board according to the invention is applied to the formation of a through-hole.

As shown in FIG. 8, also in the case where the through-hole needs to be formed, plating excellent in quality can be performed because the overhang of each of the inner conductor layers can be removed by the overhang removing step.

Although shaping of the pulse waveform has been not described above, shaping of the pulse waveform may be used so that processing quality can be improved more greatly because variation in the amount of energy supplied to the processed portion can be reduced when the pulse waveform is shaped.

Although the case of CO₂ laser light has been described, processing excellent in quality can be performed when the invention is applied also in the case where UV laser light is used as the laser light.

The coating layer of CuO capable of absorbing laser light but insoluble in the etching solution dissolving the conductor layers may be replaced by another material such as an organic material having the same characteristic.

What is claimed is:

1. A method of producing a printed circuit board comprising an alternate laminate of electric conductor layers and electrically insulating layers, wherein a coating layer capable of absorbing laser light but insoluble in an etching solution dissolving the electric conductor layers is provided on a front surface of a first one of the electric conductor layers, wherein each of the electric conductor layers contains Cu as a main component while the coating layer contains CuO as a main component, the method comprising:
removing an overhang portion of a hole inlet generated by laser processing, by treating the overhang portion with a treating solution incapable of dissolving the coating layer and the electrically insulating layer but capable of mainly dissolving the Cu component in the printed circuit board.

2. A method of producing a printed circuit board according to claim 1, wherein the treating solution is one member selected from the group consisting of a solution of ferric chloride (FeCl₃), a solution of ammonium persulfate and a solution of sodium persulfate.
